(19) United States
(12) Patent Application Publication
(10) Pub. No.: US 2015/0241133 A1
(43) Pub. Date: Aug. 27, 2015

(54) APPARATUS FOR SUPPORTING A HEATER TUBE IN A VESSEL

(71) Applicant: False Creek Welding Ltd., Spruce Grove (CA)

(72) Inventor: Eugene deGroot, Spruce Grove (CA)

(21) Appl. No.: 14/630,905

(22) Filed: Feb. 25, 2015

Related U.S. Application Data
(60) Provisional application No. 61/944,266, filed on Feb. 25, 2014.

(51) Int. Cl. F28D 11/06; F28F 9/00; B23P 15/26

(52) U.S. Cl. CPC F28D 11/06; B23P 15/26; F28F 9/00

(57) ABSTRACT

An apparatus is provided for supporting a heater tube being inserted and installed in a vessel. The apparatus can include a frame suspended from a threaded rod attached to a trolley that can move along a track disposed on the inside top surface of the vessel. The frame can include a pin configured for receiving a hook disposed on the inserted end of the heater tube. The frame can be raised or lowered on the threaded rod by rotating the frame thereon, thereby enabling the raising or lowering of the inserted end of the heater tube.

### CROSS-REFERENCE TO RELATED APPLICATIONS

This application claims priority of U.S. provisional patent application Ser. No. 61/944,266 filed Feb. 25, 2014, which is incorporated by reference into this application in its entirety.

### TECHNICAL FIELD

The present disclosure is related to the field of latch mechanisms used in supporting a supporting a heater tube in a vessel for treating bitumen, in particular, latch mechanisms that can be adjusted to raise or lower an end of the heater tube when being installed in the vessel.

### BACKGROUND

When bitumen is being heated as part of a treating process, it is placed into a large vessel, normally, horizontal in orientation, that is heated by a U-shaped heater tube inserted into the vessel from one end. The vessel has a track located on the top inside surface, running along the length thereof. A trolley mechanism can run along the track and is used to support an end of the heater tube when it is being inserted into the vessel. The heater tube typically has a closed support loop disposed on the end being inserted into the vessel and connected to the trolley mechanism with a turnbuckle device. In order to properly align and fasten a flange of the heater tube to the vessel, the inserted end of the heater tube may need to be raised or lowered so that the mounting holes of the flange can match up with corresponding bolt holes on the vessel thereby allowing the heater tube to be bolted flush with the vessel.

The current process to adjust the height of the inserted end of the heater tube requires that a service personnel to physically adjust the turnbuckle while in the vessel. As such vessels are used for the processing and treating of bitumen, the vessel contains toxic and volatile vapours and gases, thereby requiring the service personnel to wear a protective ventilated suit prior to entering the vessel. This is a time consuming and expensive process, not to mention a dangerous and hazardous activity for the service personnel entering the vessel.

It is, therefore, desirable to provide an apparatus that the height of the inserted end of the heater tube to be adjusted easily and safely, and without having service personnel enter into the vessel.

### SUMMARY

An apparatus is provided for supporting a heater tube being inserted into a vessel. In some embodiments, the apparatus can comprise a frame suspended from a trolley with a threaded rod wherein the frame is threaded onto the rod. The trolley is configured to slidably travel along a trolley track disposed on an upper inner surface of the vessel. The frame can receive a hook disposed on an end of the heater tube. The frame can further comprise a latch mechanism to secure the hook to the frame. When installing the heater tube into the vessel, the heater tube is inserted into the vessel until the mounting flange of the heater tube abuts the mounting flange of the vessel. If the flanges are not properly aligned, the heater tube is withdrawn from the vessel so that the heater tube can be unhooked from the frame so that the frame can be rotated upwards or downwards on the threaded rod whereupon the heater tube can be hooked back onto the frame and reinserted into the vessel. This process can be repeated until the mounting flanges are properly aligned when abutted together, whereupon the mounting flanges can be bolted together.

Broadly stated, in some embodiments, an apparatus can be provided for supporting a heater tube inserted into a vessel, the vessel comprising a trolley track disposed along the length of the vessel along a top inner surface thereof, the heater tube comprising a hook disposed on an end thereof, the apparatus comprising: a trolley configured for travelling along the trolley track; a frame configured for receiving the hook; and a height adjustment mechanism operatively coupling the frame to the trolley.

Broadly stated, in some embodiments, the frame can further comprise a pin configured for receiving the hook.

Broadly stated, in some embodiments, the apparatus can further comprise a latch mechanism configured for securing the hook to the frame.

Broadly stated, in some embodiments, the apparatus can further comprise a latch release mechanism whereupon activating the latch release mechanism, the heater tube can be released from the frame.

Broadly stated, in some embodiments, the latch release mechanism can further comprise a flap rotatably coupled to the frame and a counterweight disposed on the flap wherein the flap is configured to rotate towards the heater tube to prevent the hook from uncoupling from the pin.

Broadly stated, in some embodiments, the apparatus can further comprise a latch release cable operatively coupled to the counterweight whereupon tensioning the cable, the flap can be rotated away from the heater tube thereby allowing the hook to be unhooked from the pin.

Broadly stated, in some embodiments, the frame can further comprise a horizontal top plate and two substantially vertical and parallel members extending downwardly from the top plate.

Broadly stated, in some embodiments, the height adjustment mechanism can further comprise a first nut disposed on a bottom surface of the top plate, a second nut disposed on a top surface of the top place, the top plate comprising an opening disposed therethrough to provide communication between the first and second nuts, and a threaded rod suspended from the trolley, the threaded rod threaded into the first and second nuts.

Broadly stated, in some embodiments, a method can be provided for installing a heater tube into a vessel, the vessel comprising a trolley track disposed along the length of the vessel along a top inner surface thereof, the heater tube comprising a hook disposed on an end thereof, the method comprising the steps of: providing the apparatus described above; hooking the hook onto the frame of the apparatus; inserting the heater tube into the vessel wherein the trolley of the apparatus moves along the trolley track; determining if a first flange disposed on the heater tube aligns with a second flange disposed on the vessel; if the first and second flanges are not aligned: withdrawing the heater tube from the vessel, unhooking the hook from the frame, adjusting the height adjustment mechanism to raise or lower the frame, and hooking the hook back onto the frame; re-inserting the heater tube into the vessel until the first and second flanges are abutted to one another; and fastening the first and second flanges together.

### BRIEF DESCRIPTION OF THE DRAWINGS

FIG. 1 is a front elevation view depicting one embodiment of an apparatus for supporting a heater tube in a vessel.

FIG. 2 is a perspective view depicting the apparatus of FIG. 1.

FIG. 3 is a perspective view depicting the apparatus of FIG. 1 suspended from a trolley track in a vessel.

FIG. 4 is a side elevation view depicting the apparatus of FIG. 1 supporting the inserted end of a heater tube.

FIG. 5 is a perspective view depicting the apparatus of FIG. 4.

FIG. 6 is a perspective view depicting a heater tube being inserted into a vessel.

### DETAILED DESCRIPTION OF EMBODIMENTS

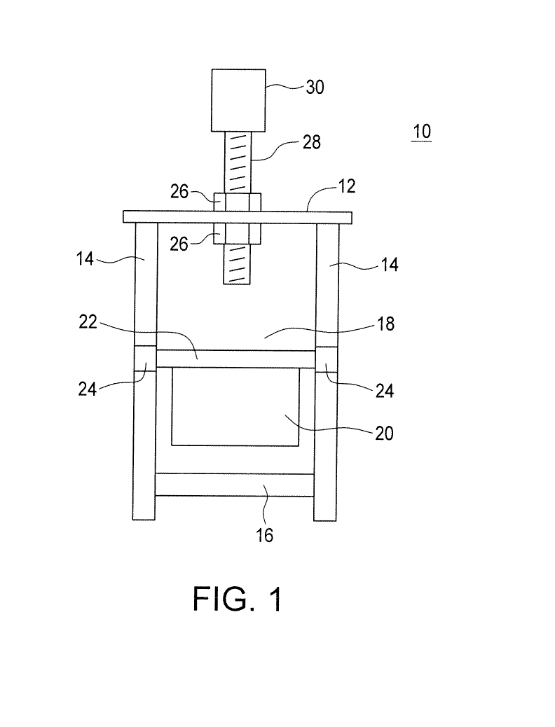

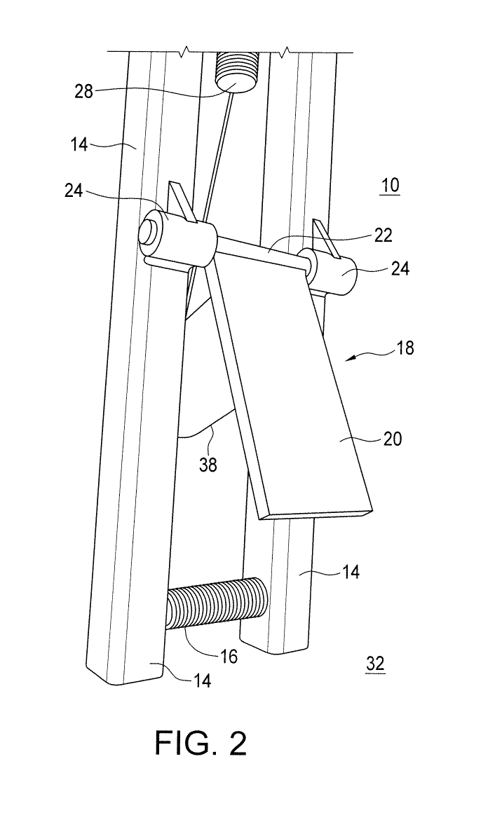

Referring to FIGS. 1 and 2, one embodiment of an apparatus for supporting a heater tube in a vessel is shown. In some embodiments, apparatus 10 can comprise a frame, further comprising top plate 12 and a pair of substantially parallel vertical members 14 extending downwardly therefrom. Apparatus 10 can comprise substantially horizontal pin 16 extending between vertical members 14 at a lower end thereof. In some embodiments, apparatus 10 can comprise nuts 26 disposed above and below top plate 12 and threaded rod 28 threaded into upper and lower nuts 26 by passing through a hole disposed through top plate 12 to provide communication between upper and lower nuts 26. In some embodiments, an upper end of threaded rod 28 can be operatively coupled to trolley 30. In some embodiments, apparatus 10 can comprise latch mechanism 18. In some embodiments, latch mechanism 18 can further comprise rod 22 rotatably disposed in sleeves 24 disposed on vertical members 14, and flap 20 extending downwardly from rod 22. Flap 20 can further comprise counterweight 38 disposed on a rear surface thereof. In some embodiments, apparatus 10 can be comprised of structural metal components welded together, as well known to those skilled in the art. The components used to assemble apparatus 10 can be selected from a suitable material, such as steel, and dimensioned to provide the necessary strength to support the weight of a heater tube, which are design considerations obvious to those skilled in the art.

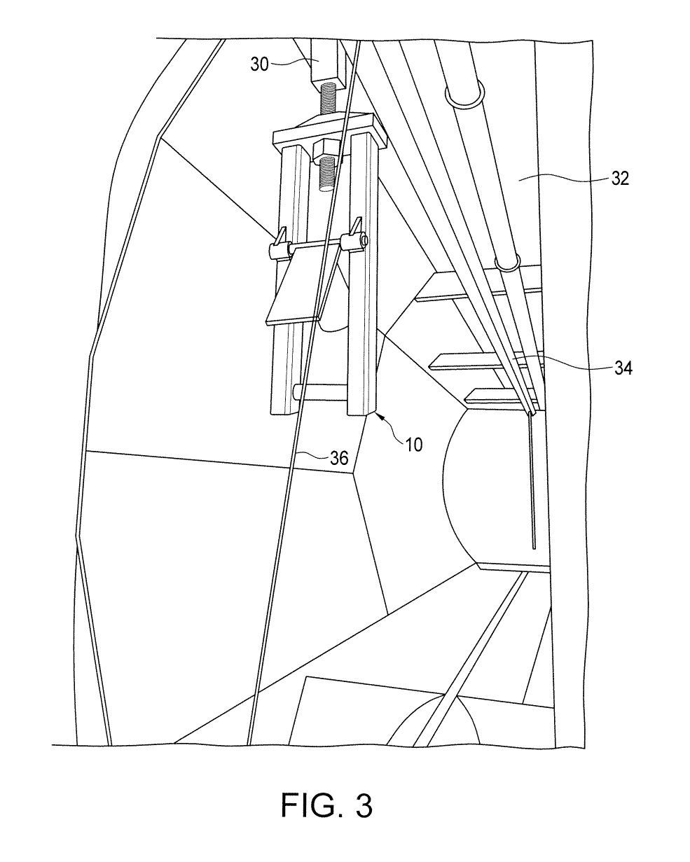

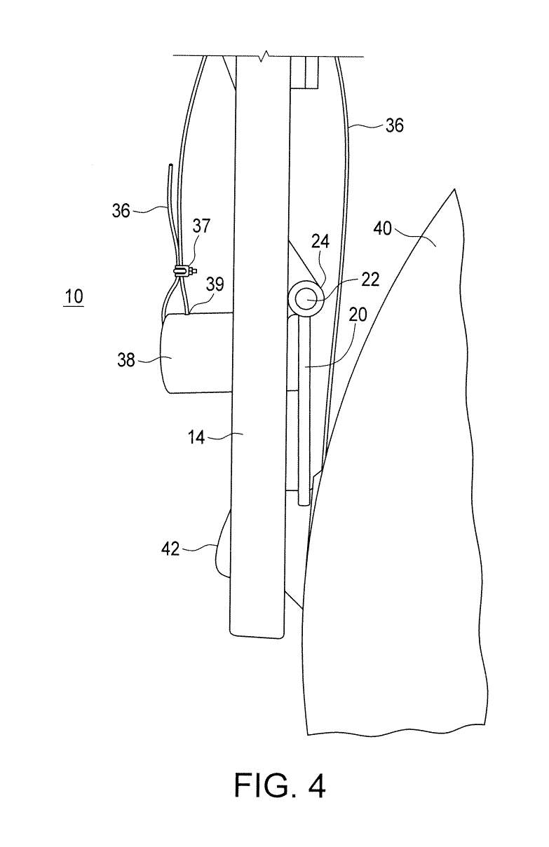

Referring to FIGS. 3 and 4, one embodiment of apparatus 10 is shown installed in vessel 32. In this embodiment, trolley 30 can be slidably disposed in trolley track 34 disposed on the upper inside surface of vessel 32. In some embodiments, apparatus 10 can comprise cable 36 connected to latch mechanism 18 to rotate flap 20 when cable 36 is put under tension.

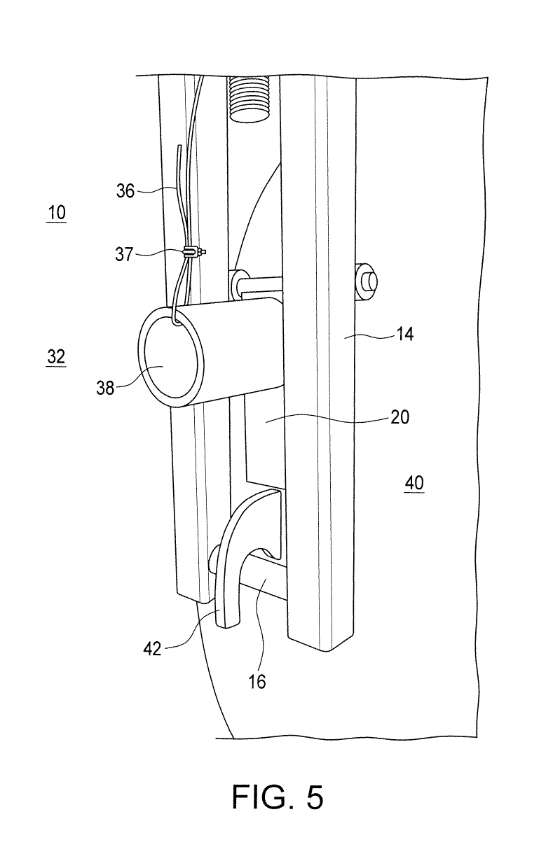

Referring to FIGS. 4 and 5, heater tube 40 is shown with hook 42 resting on pin 16. In some embodiments, cable 36 can pass through hole 39 disposed through counterweight 38 and then secured with clamp 37. When there is no tension on cable 36, counterweight 38 causes flap 20 to rotate towards to heater tube 40 such that flap 20 is positioned just above hook 42 and can prevent hook 42 from releasing from pin 16.

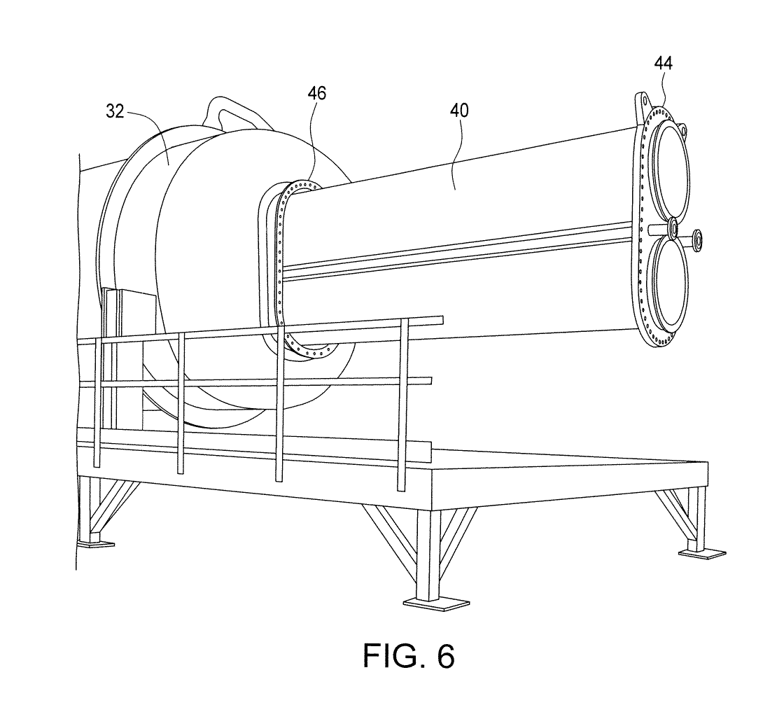

Referring to FIG. 6, heater tube 40 is shown being inserted into vessel 32. In using apparatus 10, hook 42 can engage pin 16 wherein latch mechanism 18 prevents hook 42 from releasing from pin 16. With the assistance of a crane, heater tube 40 can be inserted into vessel 32 as trolley 30 can travel along track 34 as flange 44 on heater tube 40 is brought towards flange 46 on vessel 32. If the bolt holes disposed through flange 44 do not align with the bolt holes disposed through flange 46, heater tube 40 can be withdrawn from vessel 32 wherein cable 36 can be pulled to lift flap 20 away from heater tube 40 and allow hook 42 to be lifted off of pin 16. Upon doing so, apparatus 10 can be rotated on threaded rod 28 upwards or downwards thereon as needed to align flange 44 to flange 46. This can be done when apparatus 10 is located near the opening of vessel 32 bounded by flange 46, thereby eliminating the need of having service personnel entering vessel 32 wearing a respirator suit.

Once the position of apparatus 10 is set to provide the proper alignment between flanges 44 and 46, heater tube 40 can be inserted back into vessel 32 until flange 44 is abutted against flange 46 whereupon bolts can be inserted through the bolt holes disposed through flanges 44 and 46 to fasten heater tube 40 to vessel 32.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. An apparatus for supporting a heater tube inserted into a vessel, the vessel comprising a trolley track disposed along the length of the vessel along a top inner surface thereof, the heater tube comprising a hook disposed on an end thereof, the apparatus comprising:
a) a trolley configured for travelling along the trolley track;
b) a frame configured for receiving the hook; and
c) a height adjustment mechanism operatively coupling the frame to the trolley.

2. The apparatus as set forth in claim 1, wherein the frame further comprises a pin configured for receiving the hook.

3. The apparatus as set forth in claim 2, further comprising a latch mechanism configured for securing the hook to the frame.

4. The apparatus as set forth in claim 3, further comprising a latch release mechanism whereupon activating the latch release mechanism, the heater tube can be released from the frame.

5. The apparatus as set forth in claim 4, wherein the latch release mechanism further comprises a flap rotatably coupled to the frame and a counterweight disposed on the flap wherein the flap is configured to rotate towards the heater tube to prevent the hook from uncoupling from the pin.

6. The apparatus as set forth in claim 5, further comprising a latch release cable operatively coupled to the counterweight whereupon tensioning the cable, the flap can be rotated away from the heater tube thereby allowing the hook to be unhooked from the pin.

7. The apparatus as set forth in claim 1, wherein the frame further comprises a horizontal top plate and two substantially vertical and parallel members extending downwardly from the top plate.

8. The apparatus as set forth in claim 7, wherein the height adjustment mechanism further comprises a first nut disposed on a bottom surface of the top plate, a second nut disposed on a top surface of the top place, the top plate comprising an opening disposed therethrough to provide communication between the first and second nuts, and a threaded rod suspended from the trolley, the threaded rod threaded into the first and second nuts.

9. A method for installing a heater tube into a vessel, the vessel comprising a trolley track disposed along the length of the vessel along a top inner surface thereof, the heater tube comprising a hook disposed on an end thereof, the method comprising the steps of:
a) providing an apparatus, the apparatus comprising:
i) a trolley configured for travelling along the trolley track,
ii) a frame configured for receiving the hook, and
iii) a height adjustment mechanism operatively coupling the frame to the trolley;
b) hooking the hook onto the frame of the apparatus;
c) inserting the heater tube into the vessel wherein the trolley of the apparatus moves along the trolley track;
d) determining if a first flange disposed on the heater tube aligns with a second flange disposed on the vessel;
e) if the first and second flanges are not aligned:
i) withdrawing the heater tube from the vessel,
ii) unhooking the hook from the frame,
iii) adjusting the height adjustment mechanism to raise or lower the frame, and
iv) hooking the hook back onto the frame;
f) re-inserting the heater tube into the vessel until the first and second flanges are abutted to one another; and
g) fastening the first and second flanges together.

10. The method as set forth in claim 9, wherein the frame further comprises a pin configured for receiving the hook.

11. The method as set forth in claim 10, wherein the apparatus further comprises a latch mechanism configured for securing the hook to the frame.

12. The method as set forth in claim 11, wherein the apparatus further comprises a latch release mechanism whereupon activating the latch release mechanism, the heater tube can be released from the frame.

13. The method as set forth in claim 12, wherein the latch release mechanism further comprises a flap rotatably coupled to the frame and a counterweight disposed on the flap wherein the flap is configured to rotate towards the heater tube to prevent the hook from uncoupling from the pin.

14. The method as set forth in claim 13, wherein the apparatus further comprises a latch release cable operatively coupled to the counterweight whereupon tensioning the cable, the flap can be rotated away from the heater tube thereby allowing the hook to be unhooked from the pin.

15. The method as set forth in claim 9, wherein the frame further comprises a horizontal top plate and two substantially vertical and parallel members extending downwardly from the top plate.

16. The method as set forth in claim 15, wherein the height adjustment mechanism further comprises a first nut disposed on a bottom surface of the top plate, a second nut disposed on a top surface of the top place, the top plate comprising an opening disposed therethrough to provide communication between the first and second nuts, and a threaded rod suspended from the trolley, the threaded rod threaded into the first and second nuts.
